(19) United States
(12) Patent Application Publication
(10) Pub. No.: US 2026/0296413 A1
(43) Pub. Date: Oct. 1, 2026

(54) SYSTEMS AND METHODS FOR EMERGENCY COLLISION AVOIDANCE FOR AN AUTONOMOUS VEHICLE

(71) Applicant: AVRIDE Inc., Newburyport, MA (US)

(72) Inventors: Vitaliy Podkolzin, Austin, TX (US); Konstantin Tazhimuratov, Tel Aviv (IL); Aleksandr Khlynov, Austin, TX (US); Ivan Sherstobitov, Austin, TX (US); Anton Bochkarev, Tel Aviv (IL)

(21) Appl. No.: 19/577,610

(22) Filed: Mar. 25, 2026

Related U.S. Application Data
(60) Provisional application No. 63/777,148, filed on Mar. 25, 2025.

(51) Int. Cl. B60W 30/09; B60W 10/18; B60W 60/00; G01S 15/931

(52) U.S. Cl. CPC B60W 30/09; B60W 10/18; B60W 60/0015; G01S 15/931; B60W 2420/54; B60W 2422/00; B60W 2710/18

(57) ABSTRACT

Provided herein is a system and method for emergency collision avoidance for an autonomous vehicle, the system including: a vehicle; a plurality of ultrasonic sensors attached to the vehicle and configured to collect ultrasonic data; and a computing device, wherein the computing device is configured to: receive the ultrasonic data from the plurality of ultrasonic sensors; receive one or more motion commands, wherein the motion commands are configured to instruct a vehicle to autonomously navigate; determine, as a function of the ultrasonic data from the plurality of ultrasonic sensors, an object zone for an object of ultrasonic data; alter the one or more motion commands as a function of the object zone to form altered motion commands; and command the vehicle using the altered motion commands.

### CROSS REFERENCE TO RELATED APPLICATIONS

This application claims the benefit of priority to U.S. Provisional Application No. 63/777,148, filed on Mar. 25, 2025 and entitled “EMERGENCY COLLISION AVOIDANCE SYSTEM BASED ON ULTRASONIC-SENSORS FOR AUTONOMOUS VEHICLES, SUCH AS GROUND DELIVERY ROBOTS,” the entirety of which is incorporated herein by reference.

### FIELD OF THE INVENTION

The present invention is directed generally to collision avoidance system and methods. In particular, the present invention is directed to systems and methods for emergency collision avoidance for an autonomous vehicle.

### BACKGROUND OF THE INVENTION

Historically, ultrasonic sensors are a robust, weather and environment agnostic sensor that can be processed by low-performance control systems to control a robot. They can also be used with the purpose of avoiding collision with, e.g., pedestrians, vehicles, other road users and obstacles. However, the ultrasonic sensors employed historically return only one-dimensional data (a distance to an object) within its field-of-view (FOV), which evidences a disadvantage in that it may lead to big blind zones with narrow FOV or too many flagged objects for ultrasonic sensors with a wide FOV. This issue is particularly relevant for crowded city streets. Therefore, the need exists for an ultrasonic sensor or ultrasonic sensor system that is able to obtain an accurate position of an object in front of a robot and determine possible collision with it. Furthermore, there is a need for a sensor to not only detect the position of an object ahead, but also its speed and movement direction.

Accordingly, there remains a need in the art for emergency collision avoidance systems that improve upon existing systems. The present disclosure meets this need.

### SUMMARY

In some aspects, the techniques described herein relate to a system for emergency collision avoidance for an autonomous vehicle, the system including: a vehicle; a plurality of ultrasonic sensors attached to the vehicle and configured to collect ultrasonic data; and a computing device, wherein the computing device is configured to: receive the ultrasonic data from the plurality of ultrasonic sensors; receive one or more motion commands, wherein the motion commands are configured to instruct a vehicle to autonomously navigate; determine, as a function of the ultrasonic data from the plurality of ultrasonic sensors, an object zone for an object of ultrasonic data; alter the one or more motion commands as a function of the object zone to form altered motion commands; and command the vehicle using the altered motion commands.

In some aspects, the techniques described herein relate to a method for emergency collision avoidance for an autonomous vehicle, the method including: receiving, by a computing device, ultrasonic data from a plurality of ultrasonic sensors, wherein the plurality of ultrasonic sensors are attached to a vehicle and are configured to collect the ultrasonic data; receiving, by the computing device, one or more motion commands, wherein the motion commands are configured to instruct a vehicle to autonomously navigate; determining, by the computing device and as a function of the ultrasonic data from the plurality of ultrasonic sensors, an object zone for an object of ultrasonic data; altering, by the computing device, the one or more motion commands as a function of the object zone to form altered motion commands; and commanding, by the computing device, the vehicle using the altered motion commands.

In some aspects, the techniques described herein relate to a method for emergency collision avoidance for an autonomous vehicle, the method including: generating, using a main compute unit, one or more motion commands as a function of sensor suite data; receiving, by a chassis compute unit, ultrasonic data from a plurality of ultrasonic sensors, wherein the plurality of ultrasonic sensors are attached to a vehicle and are configured to collect the ultrasonic data; receiving, by the chassis compute unit, one or more motion commands from the main compute unit, wherein the motion commands are configured to instruct a vehicle to autonomously navigate; determining, by the chassis compute unit and as a function of the ultrasonic data from the plurality of ultrasonic sensors, an object zone for an object of ultrasonic data; altering, by the chassis compute unit, the one or more motion commands as a function of the object zone to form altered motion commands; and commanding, by the chassis compute unit, the vehicle using the altered motion commands.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 shows an exemplary system for emergency collision avoidance for an autonomous vehicle;

FIG. 2 shows an exemplary ultrasound sensor arrangement;

FIG. 3 shows another exemplary ultrasound sensor arrangement;

FIG. 4 shows an exemplary distributed computing architecture;

FIGS. 5A and 5B show an exemplary vehicle computing architecture;

FIG. 6 shows an exemplary method for emergency collision avoidance for an autonomous vehicle; and

FIG. 7 shows a computing device in the exemplary form of a computer system.

### DETAILED DESCRIPTION

### Definitions

As used herein, each of the following terms has the meaning associated with it in this section. Unless defined otherwise, all technical and scientific terms used herein generally have the same meaning as commonly understood by one of ordinary skill in the art to which this disclosure belongs. Generally, the nomenclature used herein are those well-known and commonly employed in the art. It should be understood that the order of steps or order for performing certain actions is immaterial, so long as the present teachings remain operable. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference.

In the application, where an element or component is said to be included in and/or selected from a list of recited elements or components, it should be understood that the element or component can be any one of the recited elements or components and can be selected from a group consisting of two or more of the recited elements or components.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used herein, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

As used herein, the term “ratio” refers to a relationship between two numbers (e.g., scores, summations, and the like). Although, ratios can be expressed in a particular order (e.g., a to b or a:b), one of ordinary skill in the art will recognize that the underlying relationship between the numbers can be expressed in any order without losing the significance of the underlying relationship, although observation and correlation of trends based on the ration may need to be reversed. For example, if the values of a over time are (4, 10) and the values of b over time are (2, 4), the ratio a:b will equal (2, 2.5), while the ratio b:a will be (0.5, 0.4). Although the values of a and b are the same in both ratios, the ratios a:b and b:a are inverse and increase and decrease, respectively, over the time period.

For the purposes of this disclosure, a “motion command” is an electronic signal or instruction configured to cause a vehicle to enact motion or brake.

For the purposes of this disclosure, a “front side” of a vehicle is the side of a vehicle that is facing its direction of travel.

For the purposes of this disclosure, a “longitudinal axis” for a vehicle is an axis running through the center of vehicle from its front to its back.

For the purposes of this disclosure, a “path of vehicle” is the projected or expected path that a vehicle is taking.

### DETAILED DESCRIPTION

The present disclosure may be used in robotics vehicles as emergency collision avoidance system in case the main robot motion planner fails. Or, it may be used when the main robot sensors cannot detect objects around the card, including objects in blind zones. Such emergency braking systems may be completely independent from the main autopilot. Therefore, it may provide a backup if the main autopilot experiences a failure and its failures. Ultrasonic systems may have a very fast reaction, so it can be used “at the last moment.” This reduces the false negative obstacle detections amount and increases overall quality of self-driving robotic platforms. Additionally, in some embodiments, the system may smoothly slow down a vehicle in advance if there is a possibility of collision. For example, the system may limit max speed or reduce the current speed if it detects obstacles/objects in front of a vehicle. This may allow for the avoidance of emergency braking; however it may result in more false positives.

The present disclosure additionally solves problems experienced with the prior art because it provides an ultrasonic sensor that is able to obtain precise position of an object in front of a robot and determine possible collision with it. Furthermore, the present invention provides a sensor to not only detect the position of an object ahead, but its speed and movement direction as well.

The present disclosure allows for ultrasonic systems to detect objects in blind zones in front of the vehicle. The present disclosure also allows for ultrasonic systems to detect objects in blind zones behind the vehicle, such as when the vehicle is in reverse. The present disclosure provides a simple and reliable method to avoid collisions of a vehicle with objects.

### System for Emergency Collision Avoidance for an Autonomous Vehicle

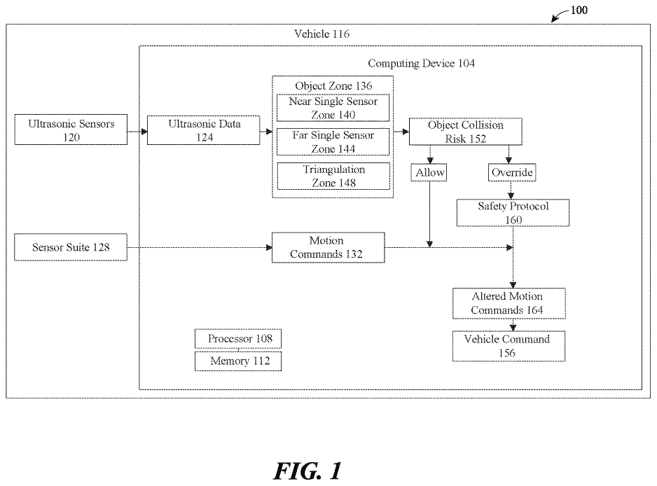

Referring now to FIG. 1, a system 100 for emergency collision avoidance for an autonomous vehicle is shown. System 100 may include circuitry such as without limitation a processor communicatively connected to a memory 112; for instance, circuitry may include and/or be included in a computing device. As used in this disclosure, “communicatively connected” means connected by way of a connection, attachment, or linkage between two or more relata such as without limitation electronic components, modules, and/or devices which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Circuitry may alternatively or additionally be implemented by configuring a hardware device such as a combinatorial or sequential logic circuit, an application-specific integrated circuit (ASIC), a field-programmable gate array (FPGA), or other hardware unit; memory may be attached thereto to further configure the hardware unit using read-only memory (ROM) or any other static or writable memory as described in this disclosure. Alternatively or additionally, hardware units and/or modules may be combined with and/or in communication with a processor 108, such as without limitation in a system-on-chip architecture wherein some functions are configured by modification or design of hardware circuitry, such as without limitation FPGA circuitry, while others are configured in the form of instructions in memory for one or more processors 108. As a non-limiting example, any step or combination of steps described herein may be performed entirely using hardware circuit configured to perform such steps either with static memory or rewritable memory. Such steps or combinations of steps may include signing with a digital signature, cryptographically hashing, evaluation of zero-knowledge proofs, or any other specific process described in this disclosure.

With continued reference to FIG. 1, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, system 100 includes a vehicle 116. A “vehicle,” for the purposes of this disclosure is a device that is designed to transport goods, people, and/or animals. In some embodiments, vehicle 116 may be motorized. As non-limiting examples, vehicle 116 may include a car, a scooter, an ebike, an ATV, a motorcycle, a motorbike, a minibike, a truck, a golf cart, an aircraft, and the like. In some embodiments, vehicle 116 may be human-powered. As non-limiting examples, vehicle 116 may include a bike, a rickshaw, a skateboard, a scooter, or the like. In some embodiments, vehicle 116 may include a robot. Robot may include, as non-limiting examples, a drone, a bot,

With continued reference to FIG. 1, vehicle 116 may include a plurality of ultrasonic sensors 120. In some embodiments, plurality of ultrasonic sensors 120 may be attached to the vehicle and configured to collect ultrasonic data 124.

With continued reference to FIG. 1, plurality of ultrasonic sensors 120 may include a transmitter. A transmitter, in the context of an ultrasonic sensor 120, is a component that is configured to convert electrical signals into ultrasound. Ultrasonic sensor 120 may include a signal generator. Signal generator may generate electrical signals for the transmitter. For example, signal generator may generate an alternating current (AC) electric signal which may be input into transmitter.

With continued reference to FIG. 1, transmitter may include a piezoelectric element. Piezoelectric element may include a solid component that is configured to deform in response to an electric current. Piezoelectric element may be configured to utilize the inverse piezoelectric effect. In the inverse piezoelectric effect, an electrical current may be applied to a piezoelectric element to cause piezoelectric element to expand or contract. This expansion/contraction causes soundwaves to emanate from piezoelectric element. Piezoelectric element in transmitter may vibrate when exposed to an electric current (e.g., an AC current) thereby creating ultrasonic soundwaves.

With continued reference to FIG. 1, transmitter may be configured to generate soundwaves above 20 kHz. In some embodiments, transmitter may be configured to generate soundwaves that are 20 kHz-500 kHz. In some embodiments, transmitter may be configured to generate soundwaves that are 30 kHz-500 kHz. In some embodiments, transmitter may be configured to generate soundwaves that are 23 kHz-40 kHz. In some embodiments, transmitter may be configured to generate soundwaves of 40 kHz.

With continued reference to FIG. 1, plurality of ultrasonic sensors 120 may include a receiver. Receiver may include a piezoelectric transducer. Piezoelectric transducer may contain a piezoelectric element. Piezoelectric transducer may operate using the piezoelectric effect wherein a piezoelectric element produces an electric signal in response to mechanical stress. In the context of plurality of ultrasonic sensors 120, soundwaves may subject a piezoelectric element to mechanical stress, thereby causing piezoelectric element to generate an electric signal. Electric signal may be used as a mechanism for a sensor to detect sound waves.

With continued reference to FIG. 1, receiver may include a capacitive transducer. Capacitive transducer may include a silicon layer. A cavity may be formed in the silicon layer, e.g., using micromachining techniques. A thin membrane may be suspended over the cavity. When ultrasonic waves are applied to the membrane, the capacitive transducer may generate an electric signal (e.g., an AC signal). Capacitive transducer may include, as a non-limiting example, a capacitive micromachined ultrasonic transducer (CMUT).

With continued reference to FIG. 1, in some embodiments, in plurality of ultrasonic sensors 120, transceiver and transducer may be combined into one element. This is called a transceiver. Transceiver may include a piezoelectric transceiver. In piezoelectric transceiver, the piezoelectric effect (and inverse-piezoelectric effect) may be used to both receive and transmit soundwaves.

With continued reference to FIG. 1, in some embodiments, plurality of ultrasonic sensors 120 may include 2-5 ultrasonic sensors. In some embodiments, plurality of ultrasonic sensors 120 may include 2-3 ultrasonic sensors. In some embodiments, plurality of ultrasonic sensors 120 may include 2 ultrasonic sensors. In some embodiments, plurality of ultrasonic sensors 120 may include 3 ultrasonic sensors.

With continued reference to FIG. 1, an ultrasound sensor may detect a distance to an object. Distance to an object may be determined by measuring the time difference between when a sound signal is emitted by the ultrasonic sensor or another ultrasonic sensor and the time at which a return sound signal is detected by the ultrasonics sensor. In this case, a single ultrasonic sensor may be able to detect a distance of an object from the ultrasonic sensor. However, a single ultrasonic sensor is not generally able to determine a position of an object relative to the ultrasonic sensor.

With continued reference to FIG. 1, in some embodiments, object distance could be estimated with speed. However, this fact itself may not, in some embodiments, improve the ability to detect relative position of an object to the vehicle, since the FOV is to wide, so it's unclear where the object is and where it is heading. On the other hand, having information of the objects relative speed on top of the distance to the object may allow to make this system ant calculations more precision and robust.

With continued reference to FIG. 1, therefore, plurality of ultrasonic sensors 120 may be used to determine a distance of an object. This may include using, e.g., triangulation. For example, a first ultrasonic sensor may determine a first distance for an object and a second ultrasonic sensor may determine a second distance for an object. Second distance and first distance, as well as the locations of the respective positions may be used to determine the position of the object using the principles of triangulation.

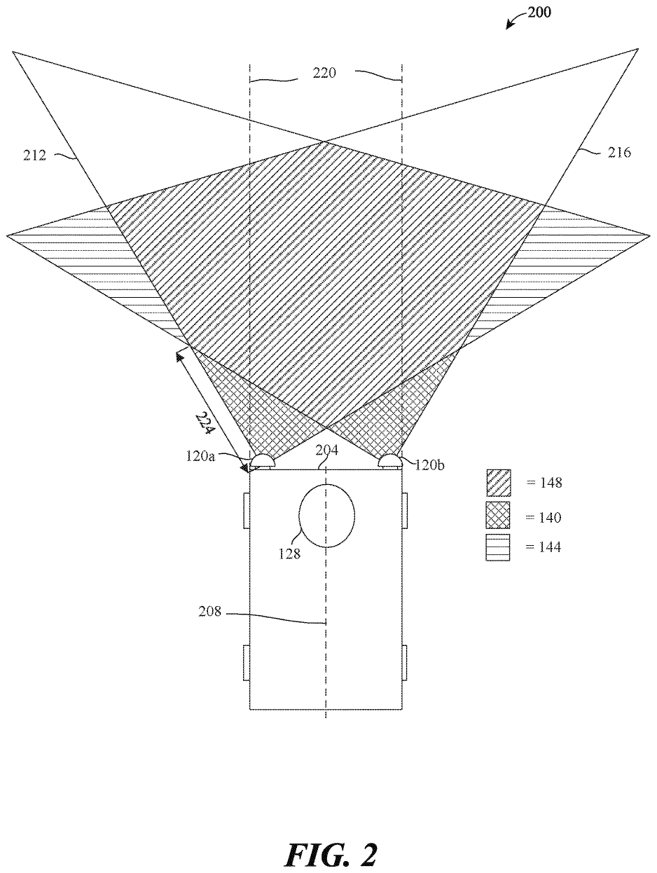

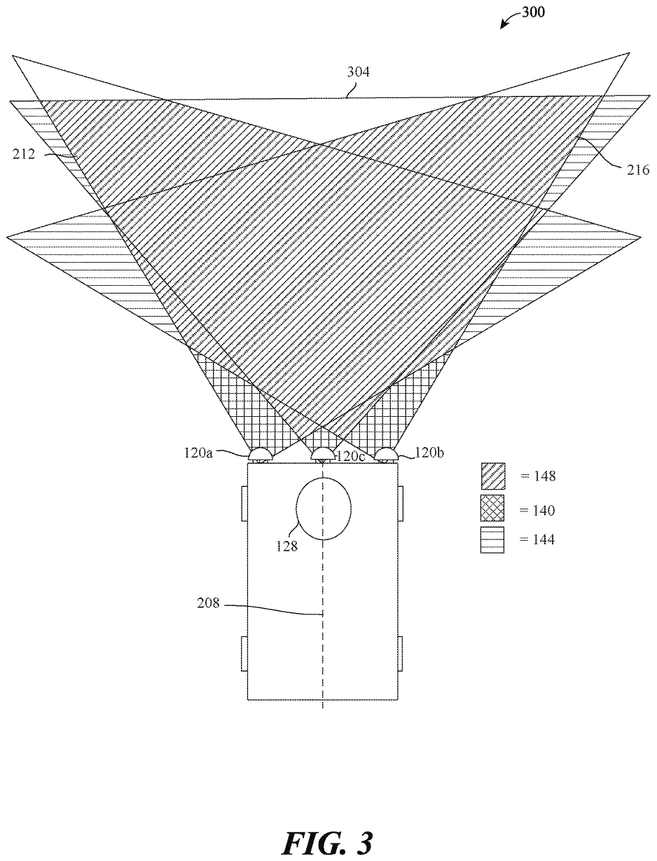

With continued reference to FIG. 1, plurality of ultrasonic sensors 120 may include two ultrasonic sensors wherein two ultrasonic sensors may be a cost effective approach. This may be because two ultrasonic sensors provide adequate coverage of blind zone while minimizing cost. In some embodiments, this may be because the field of view of the two ultrasonic sensors provides adequate resolution. This may also be the case because the two ultrasonic sensors may be always listening (i.e. one of the two is always listening while the other is transmitting). In some embodiments, more than two ultrasonic sensors may be included to increase accuracy. Additionally, more than two ultrasonic sensors may provide better zone coverage (see, e.g., FIGS. 2 and 3).

With continued reference to FIG. 1, two ultrasonic sensors may be placed on a side of vehicle 116. In some embodiments, two ultrasonic sensors may be placed on each side of vehicle 116. Algorithms, for example as discussed throughout this disclosure, may be used to determine the speed, position, and/or direction of an object in front of the relevant side of vehicle 116. The placement and/or number of ultrasonic sensors may depend on parameters of the ultrasonics sensors (such as, as a non-limiting example, field of view). For example, if an ultrasonic sensor's field of view is lower, more ultrasonic sensors may be necessary to achieve desired performance. As another example, if an ultrasonic sensor's field of view is higher, less ultrasonic sensors may be required to achieve desired performance.

With continued reference to FIG. 1, system 100 may include a sensor suite 128. In some embodiments, sensor suite may include a light detection and ranging (LIDAR) system. A LIDAR system is a system that uses lasers to measure distances as a function of measuring reflected light. LIDAR system may include a laser component that may emit an emitted laser beam and LIDAR system may detect when they reflect back to the LIDAR system in the form of returning beams of light. In some embodiments, laser component may be configured to emit near-infrared light. In some embodiments, laser component may be configured to emit short-wavelength infrared light. In some embodiments, laser component may emit light with a wavelength of 905 nm and 1550 nm.

With continued reference to FIG. 1, LIDAR system may include a Light sensor. Light sensor may be configured to detect returning beams of light. Light sensor may be configured to both detect light and the time at which light is detected. In some embodiments, Light sensor may include a photodiode. A photodiode is a semiconductor diode sensitive to photon radiation, such as visible light, infrared or ultraviolet radiation, X-rays and gamma rays. Photodiode may produce an electrical current when it absorbs photons. Photodiode may include a PIN structure or p-n junction. As a non-limiting example, when a photon of sufficient energy strikes the diode, it creates an electron-hole pair.

With continued reference to FIG. 1, LIDAR system may include one or more mirrors or reflective surfaces. The mirrors or reflective surfaces may be configured to redirect and/or reflect emitted laser beam and/or returning beam. As a non-limiting examples, LIDAR system may include a scanning mirror. Sanning mirror may be configured to reflect an emitted laser beam from laser component 705 out of LIDAR system and towards, e.g., object. Scanning mirror may be configured to rotate about a vertical axis. As a non-limiting example, this may allow LIDAR system to scan a 360 degree area as scanning mirror is rotated about the vertical axis. In some embodiments, scanning mirror may be configured to rotate about a transverse axis. As a non-limiting example, this may allow lidar system to adjust the scanning area vertically. In some embodiments, LIDAR system may include a sensor mirror. Sensor mirror may be configured to reflect returning beam to light sensor.

With continued reference to FIG. 1, sensor suite 128 may include one or more cameras. One or more cameras may include a plurality of cameras. In some cases, a camera may include one or more optics. Exemplary non-limiting optics include spherical lenses, aspherical lenses, reflectors, polarizers, filters, windows, aperture stops, and the like. In some embodiments, one or more optics associated with a camera may be adjusted in order to, in non-limiting examples, change the zoom, depth of field, and/or focus distance of the camera. In some embodiments, an autofocus mechanism may be used to determine focus distance. In some embodiments, at least a camera may include an image sensor. Exemplary non-limiting image sensors include digital image sensors, such as without limitation charge-coupled device (CCD) sensors and complimentary metal-oxide-semiconductor (CMOS) sensors. In some embodiments, a camera may be sensitive within a non-visible range of electromagnetic radiation, such as without limitation infrared. In some embodiments, a camera may include a video camera.

With continued reference to FIG. 1, sensor suite 128 may be mounted on vehicle 116. In some embodiments, sensor suite 128 may be mounted on a roof of vehicle 116. In some embodiments, one or more cameras may be mounted in a circular arrangement (e.g., on roof of vehicle 116). For example, this may allow the one or more cameras to detect a 360 degree view of the surroundings of the vehicle.

With continued reference to FIG. 1, sensor suite 128 may include one or more microphones. In some embodiments, one or more microphones may include a microphone array. System 100 may include one or more microphones. In some embodiments, one of more microphones may be located on a vehicles 116 rooftop. This may allow for improved quality of surround sound data. In some embodiments, one of more microphones may be located below LIDAR sensor. In some embodiments, one of more microphones may be located below one or more cameras.

With continued reference to FIG. 1, computing device 104 may be configured to receive ultrasonic data 124 from plurality of ultrasonic sensors 120. This may include, for example, receiving detection data collected by plurality of ultrasonic sensors 120. Computing device 104 may then, optionally, process the detection data to determine the positions of object detected by plurality of ultrasonic sensors 120

With continued reference to FIG. 1, computing device 104 may be configured to generate one or more motion commands 132 as a function of sensor suite data from sensor suite 128. In some embodiments, motion commands 132 may include one or more commands generated by autonomous driving algorithms. Autonomous driving algorithms may include any autonomous driving algorithms known to those of skill in the art. In some embodiments, the autonomous driving algorithms may be configured to receive, as input, sensor data from sensor suite 128 and output one or more one or more motion commands 132. For a non-limiting example, autonomous driving algorithms may use LIDAR data collected by LIDAR system to generate one or more motion commands 132. As another non-limiting example, autonomous driving algorithms may use LIDAR data and/or camera data collected by the LIDAR system and cameras (respectively) to generate one or more motion commands 132.

With continued reference to FIG. 1, computing device 104 may be configured to determine, as a function of the ultrasonic data 124 from the plurality of ultrasonic sensors 120, an object zone 136 for an object of ultrasonic data. Object zone 136 may be determined based on, as a non-limiting example, the number of ultrasonic sensors 120 that detected object or which ultrasonic sensor 120 of plurality of ultrasonic sensors 120 detected the object. In some embodiments, object zones 136 may include a near single sensor zone 140, a far single sensor zone 144, and a triangulation zone 148. Near single sensor zone 140, far single sensor zone 144, and a triangulation zone 148 are exemplary; those skilled in the art, after having read the entirety of this disclosure, would understand that a variety of different zones may be used based on, as non-limiting examples, the number of ultrasonic sensors 120, the position of ultrasonic sensors 120, and the specific object detection factors desired. In some embodiments, object zone 136 may be determined to be a single sensor zone, wherein a single sensor zone is an area in which an object is detected wherein the object is only detectable by one ultrasonic sensor 120. In some embodiments, object zone may include a triangulation zone, wherein a triangulation zone is an area in which an object is detected wherein the object is detectable by more than one ultrasonic sensor 120. Object zones 136 and ultrasonic sensor 120 positions are further described with respect to FIGS. 2 and 3.

Referring now to FIG. 2, an exemplary ultrasound sensor arrangement 200 is shown. Ultrasound sensor arrangement 200 may include a first ultrasound sensor 120a and a second ultrasound sensor 120b. In some embodiments, one or more ultrasound sensors may be located on a front side 204 of a vehicle. For example, front side of vehicle may be located in front of a driver's seat of said vehicle. In some embodiments, second ultrasound sensor 120b may be located on front side 204 of vehicle.

With continued reference to FIG. 2, FIG. 2 depicts a diagram a placement of first ultrasound sensor 120a and second ultrasound sensor 120b showing a possible setup of the at least two sensors. The two ultrasonic sensors may be positioned in arrangement 200 to cover the area on one side of vehicle. As a non-limiting example, a similar, analogous set up and operation could be implemented for the read side, left side, and/or right side of the vehicle. This positioning of first ultrasound sensor 120a and second ultrasound sensor 120b allows the use of triangulation in most of the area of interest as the main zone of interest (e.g., see triangulation zone 148). The placement of first ultrasound sensor 120a and second ultrasound sensor 120b allows the sensors to split the whole area in front of a robot into different zones with different behavior as described below. This novel approach presents an improvement over normal practices.

With continued reference to FIG. 2, vehicle may include a longitudinal axis 208. In some embodiments, longitudinal axis may be consistent with longitudinal axis 208 as shown in FIG. 2. In some embodiments, first ultrasound sensor 120a may be located to the left of longitudinal axis 208 of vehicle. In some embodiments, second ultrasound sensor 120b may be located to the right of longitudinal axis 208. The use of “left” and “right” to describe the positions of ultrasonic sensors is relative to the view shown in FIG. 2.

With continued reference to FIG. 2, first ultrasound sensor 120a may view a first field of view 212. First field of view 212 may be a cone emanating from first ultrasound sensor 120a. First field of view 212 is the area in front of first ultrasound sensor 120a that first ultrasound sensor 120a is able to see. Second ultrasound sensor 120b may include a second field of view 216. Second field of view 216 may be a cone emanating from second ultrasound sensor 120b. Second field of view 216 is the area in front of second ultrasound sensor 120b that second ultrasound sensor 120b is able to see.

With continued reference to FIG. 2, sensor suite 128 may be located on the vehicle. Computing device may be configured to determine an object zone for an object of ultrasonic data as a function of ultrasonic data from first ultrasound sensor 120a and second ultrasound sensor 120b. Determining an object zone may include determining object to be in a triangulation zone 148. Triangulation zone 148 is an area wherein an object is viewable by at least two ultrasonic sensors. In the triangulation zone 148, the distance from first ultrasound sensor 120a and second ultrasound sensor 120b to the position of an object can be determined. Using a few consequent measurements, the system may determine the object's velocity while it is in triangulation zone 148. This enables a reaction only to those objects whose position (for static objects) or trajectory (for dynamic objects) intersect with the trajectory of the vehicle's movement.

With continued reference to FIG. 2, determining an object zone for an object of ultrasonic data as a function of ultrasonic data may include determining the object zone to be in a triangulation zone 148 if the object is detected in the ultrasonic data from each of the plurality of ultrasonic sensors. A computing device may be configured to perform one or more actions as a function of determining the object zone to be triangulation zone 148. In some embodiments, if object zone is determined to be triangulation zone 148, computing device may determine an object collision risk as a function of the ultrasonic data. For example, determining the object collision risk may include determining a trajectory and/or speed of object and comparing that to the trajectory and/or speed of the vehicle. As a non-limiting example, if the object is moving quickly left-to-right at a distance of 15 meters, while vehicle is moving forwards, computing device may determine that collision risk is negative. As a non-limiting example, if the object is moving toward the vehicle at a distance of 8 meters, while vehicle is moving forwards, computing device may determine that collision risk is positive.

With continued reference to FIG. 2, determining an object zone for an object of ultrasonic data as a function of ultrasonic data may include determining an object zone to be a single sensor zone if the object is only detected in the ultrasonic data from one ultrasonic sensor 120 of the plurality of ultrasonic sensors 120. Single sensor zone could include, near single sensor zone 140 or far single sensor zone 144. If the object zone is in the single sensor zone, then computing device may be configured to override the motion commands to institute the safety protocol if the object zone is the single sensor zone.

With continued reference to FIG. 2, determining an object zone for an object of ultrasonic data as a function of ultrasonic data may include determining an object zone to be a near single sensor zone 140 if an object is detected by only one ultrasonic sensor within a path of vehicle 220. If the object zone is in the near single sensor zone 140, then computing device may be configured to override the motion commands to institute the safety protocol if the object zone is the near single sensor zone 140.

With continued reference to FIG. 2, near single sensor zone 140 may represent a dangerous area for an object to be. For example, this is an area that is close to the vehicle. Additionally, since it is only visible to one ultrasonic sensor, therefore, it is hard to tell the exact location of the object. Therefore, if an object is detected in near single sensor zone 140 then a safety protocol may be implemented to stop as soon as possible. In some embodiments, emergency breaking may be applied immediately if an object is detected in near single sensor zone 140. In some embodiments, near single sensor zone 140 may be only observable by the ultrasonic sensor on the near side of vehicle.

With continued reference to FIG. 2, determining an object zone for an object of ultrasonic data as a function of ultrasonic data may include determining the object zone to be a far single sensor zone 144 if an object is detected by only one ultrasonic sensor outside of the path of the vehicle 220. In some embodiments, far single sensor zone 144 may be only observable by the ultrasonic sensor on the far side of vehicle. If the object zone is determined to be the far single sensor zone 144, computing device may be configured to allow the motion commands. For example, this may include allowing the motion commands without modification.

With continued reference to FIG. 2, in some embodiments, objects in far single sensor zone 144, or those that moves from triangulation zone 148 to far single sensor zone 144 may be ignored. For example, motion commands may be passed on to be executed by the vehicle without modification. This may be because far single sensor zone 144 represents an area outside of vehicle 220. This represents and improvement to the art that allows the vehicle to better move in very narrow spaces, including crowded streets.

With continued reference to FIG. 2, exemplary ultrasound sensor arrangement 200 may include a ring back distance 224.

Referring now to FIG. 3, another exemplary ultrasound sensor arrangement 300 is shown. Ultrasound sensor arrangement 300 may include a first ultrasound sensor 120a, second ultrasound sensor 120b, and third ultrasound sensor. In some embodiments, the plurality of ultrasonic sensors 120 (as seen in FIG. 1) may include first ultrasonic sensor 120a, a second ultrasonic sensor 120b, and a third ultrasonic sensor 120c.

With continued reference to FIG. 3, In some embodiments, one or more ultrasound sensors may be located on a front side of a vehicle. For example, in some embodiments, third ultrasonic sensor 120c may be located on front side of vehicle. Front side of vehicle may be consistent with front side 204 as described with reference to FIG. 2. In some embodiments, third ultrasonic sensor 120c may be located in a center of front side of vehicle. In some embodiments, 120c may be located on the longitudinal axis 208 of the vehicle.

With continued reference to FIG. 3, third ultrasonic sensor 120c may have a field of view 304. In some embodiments, first ultrasound sensor 120a, field of view 212, second ultrasound sensor 120b, and field of view 216 may be consistent with their description with reference to FIG. 2.

Referring back to FIG. 1, in some embodiments, as a function of object zone 136, computing device 104 may be configured to determine an object collision risk 152. Determination of object collision risk 152 is further described above with respect to FIGS. 2 and 3. As a non-limiting example, if an object is detected in near single sensor zone 140, object collision risk 152 may be determined to be positive. As another non-limiting example, for objects in triangulation zone 148, computing device 104 may determine a trajectory or speed of the object and the vehicle in order to determine object collision risk 152.

With continued reference to FIG. 1, if object collision risk 152 is determined to be negative, then computing device 104 may allow one or more motion commands 132. This may include, in some embodiments, issuing a vehicle command 156 in accordance with unaltered one or more motion commands 132.

With continued reference to FIG. 1, if object collision risk 152 is determined to be positive, then computing device 104 may override one or more motion commands 132. Overriding one or more motion commands 132 may include altering one or more motion commands 132. In some embodiments, overriding one or more motion commands 132 may include substituting one or more motion commands 132. In some embodiments, overriding one or more motion commands 132 may include instituting a safety protocol 160.

With continued reference to FIG. 1, the algorithms of computing device 104 may allow the use of an alternation mode for plurality of ultrasonic sensors 120. As a non-limiting example, this may include, when one or all of plurality of ultrasonic sensors 120 emit a signal and all of plurality of ultrasonic sensors 120, including emitters, listen to the response. Each time the emitting sensor of plurality of ultrasonic sensors 120 changes, it allows better results for different types of obstacles. This synchronous listening is an important improvement that allows understanding the position of an object regarding vehicle 116. In some embodiment, if two of plurality of ultrasonic sensors 120 were used to emit concurrently, usually both sensors can see reflections. In other words, if two of plurality of ultrasonic sensors 120 were used to emit concurrently, it would cause interference. This is not desired as it leads to noisy or inaccurate data. Instead, it is better to have one ultrasonic sensor emit while the other receives. Additionally, this method of synchronous listening (where one ultrasonic sensor emits) has a benefit of allowing for very fast sensing. This is because normally, there is a delay period where ultrasonic sensor cannot listen after it has emitted. For example, after an ultrasonic sensor emits a pulse of sound, there is usually a delay before that sensor can hear what they emitted-however that is not the case for another sensor that is listening.

With continued reference to FIG. 1, in some embodiments, plurality of ultrasonic sensors 120 may measure position in a two-dimensional (2d) plane, where no elevation is measured. In some embodiments, the plurality of ultrasonic sensors 120 should be allowed to emit and listen for data with high enough cycle frequencies. To get better results, the cycle time may be 20 ms or less. Such frequency may allow for the ability to determine the position of the object with frequencies 50 Hz and higher, so may allow for determination of not only the position of the object, but also its speed and direction. In some embodiments, the cycle time may be selected based on system requirements. If a system needs to detect longer distances, for example, the cycle time should be bigger to allow sound flight to an object and back to a sensor. If a system needs shorter detection distances, for example, the cycle time may be shorted, it allows to have faster object detection and tracking. However faster cycle time may require additional filtration, from double-triple-and multiple-reflections.

With continued reference to FIG. 1, in some embodiments, system 100 may include tracking software algorithms. Tracking software algorithms may be configured to remember each detected object and store one or more of its features in memory. Its features may include, as non-limiting examples, position, and/or velocity. The tracking software algorithms may be configured to refresh this data at each cycle time. This may allow for precise prediction of whether the object is going to collide with the vehicle 116 and therefore quick determination of whether to slow down the vehicle 116 down or stop it.

With continued reference to FIG. 1, in some embodiments, computing device 104 may be configured to first emit a first ultrasonic pulse with a first ultrasonic sensor while detecting ultrasonic data with a second ultrasonic sensor. Then computing device 104 may be configured to second emit a second ultrasonic pulse with the second ultrasonic sensor while detecting the ultrasonic data with the first ultrasonic sensor. This may be an exemplary implementation of the synchronous listening process described above.

With continued reference to FIG. 1, computing device 104 may be configured to alter one or more motion commands 132 as a function of object zone 136 to form altered motion commands 164. This may include, for example, passing the one or more motion commands 132 through by not altering them; for example, if there is no object collision risk 152 detected. This may include, for example, altering one or more motion commands 132 to form altered motion commands for example, to institute safety protocol 160. This may be done if an object collision risk 152 is detected.

With continued reference to FIG. 1, in some embodiments safety protocol 160 may include applying brakes. In some embodiments, applying brakes may include slowing the vehicle 116 such that the trajectory of vehicle 116 and the trajectory of object do not intersect. In some embodiments, applying brakes may include bringing vehicle 116 to a stop. In some embodiments, emergency braking of safety protocol 160 may begin before the point at which continuing to move at the current speed and trajectory would lead to a collision. At high speeds this distance increases due to the increase in braking distance and at low speeds it decreases, tending to the minimum distance.

With continued reference to FIG. 1, computing device 104 may be configured to command vehicle 116 using altered motion commands 164. This may include, for example, transmitting one or more control signals to one or more components of vehicle. This may include applying brakes, steering the car, turning on one or more lights, hazard lights, or turn signals, honking, or the like.

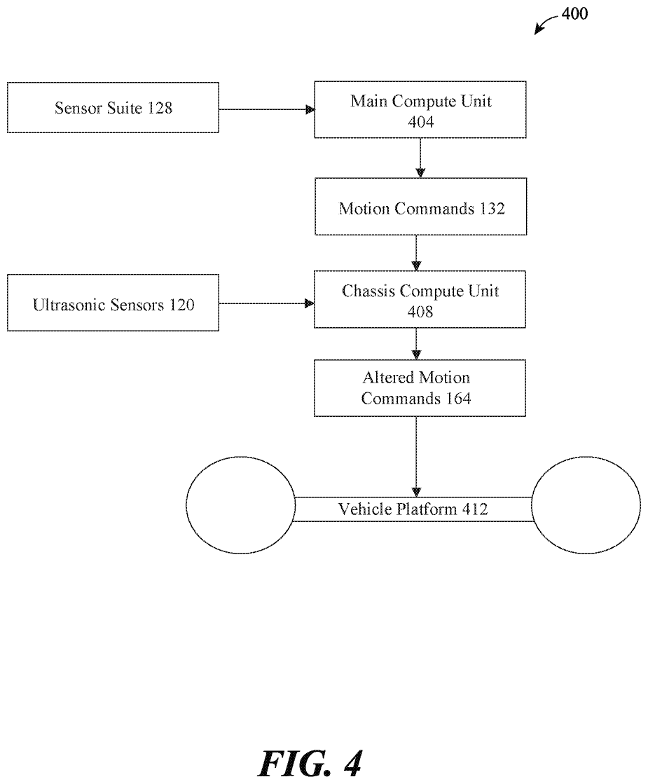

Referring now to FIG. 4, an exemplary distributed computing architecture 400 is shown. In some embodiments, exemplary distributed computing architecture 400 may include a distributed computing architecture, wherein distributed computing architecture is configure to perform one or more of the functions ascribed to computing device 104 further described with respect to FIG. 1. In some embodiments, exemplary distributed computing architecture 400 may include a main compute unit 404. In some embodiments, exemplary distributed computing architecture 400 may include a chassis compute unit 408.

With continued reference to FIG. 4, main compute unit 404 may be configured to receive data from sensor suite 128 as described further with respect to FIG. 1. In some embodiments, exemplary distributed computing architecture 400 may include only one main compute unit 404. Main compute unit 404 may be configured to process sensor data from sensor suite 128. Main compute unit 404 may be configured to generate the one or more motion commands 132 as a function of sensor suite data. Main compute unit 404 may receives data from main sensors, such as lidars, radars, cameras and process this data. Main compute unit 404 may use autonomous driving algorithms to calculate the necessary motion commands 132. One or more motion commands 132 may include, as non-limiting examples, acceleration, braking, steering, and the like. In some embodiments, main compute unit 404 may be configured to send one or more motion commands 132 to chassis compute unit 408.

With continued reference to FIG. 4, chassis compute unit 408 may be configured to receiver one or more motion commands 132 from main compute unit 404. In some embodiments, exemplary distributed computing architecture 400 may include a plurality of chassis compute unit 408. For example, there may be a chassis compute unit 408 for each wheel of vehicle 116. In some embodiments, there may be two chassis compute unit 408. In some embodiments, there may be a first chassis compute unit 408 associated with a front set of wheels and a second chassis compute unit 408 associated with a back set of wheels.

With continued reference to FIG. 4, main compute unit 404 may receive data from plurality of ultrasonic sensors 120. Main compute unit 404 may be configured to process the ultrasonic data from plurality of ultrasonic sensors 120. Main compute unit 404 may be configured to, as a function of the ultrasonic data, decide whether one or more motion commands 132 received from the autopilot (e.g., main compute unit 404) are safe to be executed by the vehicle platform 412. If the algorithms used by the chassis compute unit 408 detect possible collision, they may override one or more motion commands 132 from main compute unit 404 and slow down the vehicle or stop it by generating the necessary altered motion commands 164.

With continued reference to FIG. 4, chassis compute unit 408 may be configured to determine, as a function of the ultrasonic data from the plurality of ultrasonic sensors 120, the object zone for the object of ultrasonic data. Chassis compute unit 408 may be configured to alter the one or more motion commands 132 as a function of the object zone to form altered motion commands 164. Chassis compute unit 408 may be configured to command the vehicle platform 412 using the altered motion commands 164.

### Exemplary Vehicle Computing Architecture

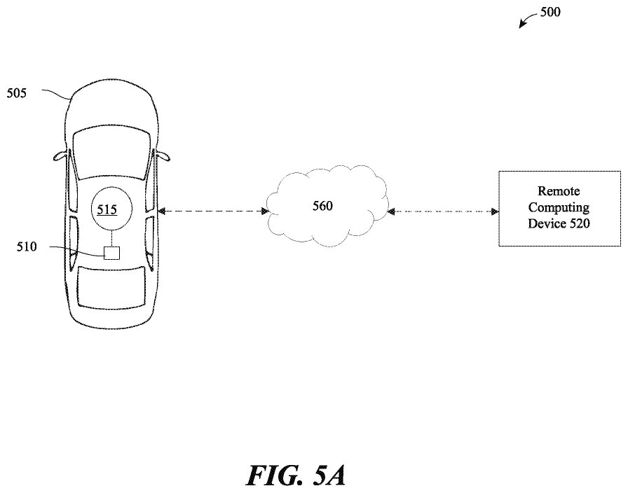

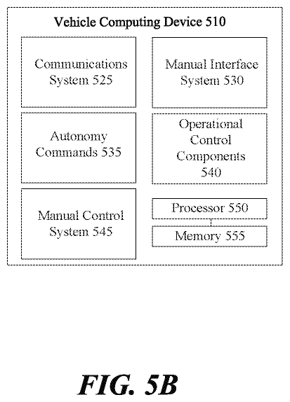

Referring now to FIGS. 5A and 5B, an exemplary vehicle computing architecture 500 is shown. Vehicle computing architecture 500 may include a vehicle 505. A “vehicle,” for the purposes of this disclosure is a device that is designed to transport goods, people, and/or animals. In some embodiments, vehicle 505 may be motorized. As non-limiting examples, vehicle 505 may include a car, a scooter, an ebike, an ATV, a motorcycle, a motorbike, a minibike, a truck, a golf cart, an aircraft, and the like. In some embodiments, vehicle 505 may be human-powered. As non-limiting examples, vehicle 505 may include a bike, a rickshaw, a skateboard, a scooter, or the like.

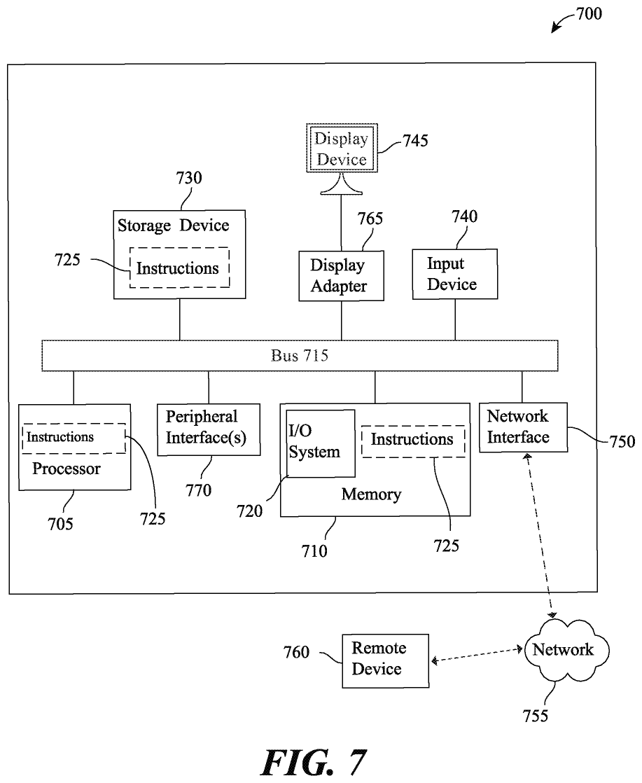

With continued reference to FIGS. 5A AND 5B, the vehicle 505 may be an autonomous vehicle that may drive, navigate, operate, etc. with minimal and/or no interaction from a human driver. Vehicle 505 may include a vehicle computing device 510 that implements a variety of systems on-board the vehicle 505. In some embodiments, vehicle computing device 510 may be consistent with aspects of computing device 700 described further with respect to FIG. 7.

With continued reference to FIGS. 5A and 5B, in some embodiments, vehicle computing architecture 500 may include one or more data acquisition systems 515. A data acquisition systems 515 may include a plurality of sensors configured to detect data from the environment surrounding or inside of vehicle 505. In some embodiments, data acquisition system 515 may include one or more cameras. Cameras may include, as non-limiting examples, wide-angle cameras, high-resolution cameras, panoramic cameras, two-dimensional cameras, three-dimensional cameras, video cameras, and the like. In some embodiments, data acquisition system 515 may include one or more LIDAR sensors. In some embodiments, data acquisition system 515 may include one or more ultrasound sensors. For example, ultrasound sensors may be mounted around the perimeter of vehicle 505. In some embodiments, ultrasound sensors may be located on the corners of vehicle 505. In some embodiments, ultrasound sensors may be used for object detection and/or collision avoidance. In some embodiments, data acquisition system 515 may include one or more microphones. In some embodiments, microphones may be arranged in an array. In some embodiments, microphones may include directional microphones. In some embodiments, microphones may include unidirectional microphones. In some embodiments data acquisition system 515 may include one or more RADAR sensors. In some embodiments, data acquisition system 515 may include, as non-limiting examples, lane detectors, optical readers, electric eyes, and/or other suitable types of image capture devices.

With continued reference to FIGS. 5A and 5B, vehicle computing device 510 may include a plurality of vehicle computing devices 510. As a non-limiting example, in some embodiments, vehicle computing device 510 may include, a central computing device and one or more auxiliary computing devices. In some embodiments, auxiliary computing devices may be located on or in the vehicle 505 roof. In some embodiments, auxiliary computing devices may be located close to certain sensors of data acquisition system 515 that they are configured to process data for. For example, auxiliary computing devices configured to process camera data may be located near cameras. For example, auxiliary computing devices configured to process LIDAR data may be located near LIDAR sensors. This may serve, for example, as an edge computing implementation, wherein, for example, data processing for certain sensors or sources of data may be offloaded to auxiliary computing devices that are closer to the sensors of sources of data of interest. This may beneficially impact data processing as it allows for data to be processed sooner after it is collected.

With continued reference to FIGS. 5A and 5B, the vehicle 505 may be configured to enter into a ready state. The ready state may indicate that the vehicle 505 is ready to operate (and/or return to) an autonomous navigation mode. A computing device on-board the vehicle 505 may be configured to determine whether the vehicle 505 is in the ready state. A remote computing device 520 (e.g., associated with an operations control center) may indicate that the vehicle 505 is ready to begin and/or resume autonomous navigation.

With continued reference to FIGS. 5A and 5B, for instance, the vehicle computing system 510 may include a communications system 525, one or more manual interface systems 530, one or more data acquisition systems 515, an autonomy command 535, one or more operational control components 540, and/or a manual control system 545.

With continued reference to FIGS. 5A and 5B, the manual interface systems 530 may be configured to allow interaction between a user (e.g., human) and the vehicle 505 (e.g., the vehicle computing system 510). The manual interface systems 530 may include a variety of interfaces for the user to input and/or receive information from the vehicle computing system 510. The manual interface systems 530 may include one or more input device(s) (e.g., touchscreens, keypad, touchpad, knobs, buttons, sliders, switches, mouse, gyroscope, microphone, other hardware interfaces) configured to receive user input. The manual interface systems 530 may include a user interface (e.g., graphical user interface, conversational and/or voice interfaces, chatter robot, gesture interface, other interface types) for receiving user input.

With continued reference to FIGS. 5A and 5B, vehicle computing system 510 may include a processor 550 and a memory 555. Processor 550 and memory 555 may be consistent with other processors and memory described throughout this disclosure. Processor 550 and memory 555 may be communicatively connected. Memory 555 may contain instructions (e.g., software) configured to cause processor 550 to perform one or more actions in accordance with this disclosure.

With continued reference to FIGS. 5A and 5B, vehicle computing architecture 500 may include a remote computing device 520. the remote computing device 520 may include and/or otherwise be associated with one or more computing devices (e.g., computing device 700, referred to in FIG. 7) that are remote from the vehicle 505. The remote computing device 520 may communicate with the vehicle 505 via one or more communications networks 560. The communications network 560 may include various wired and/or wireless communication mechanisms (e.g., cellular, wireless, satellite, microwave, and radio frequency) and/or any desired network topology. For example, the communications network 560 may include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 505.

### Method for Emergency Collision Avoidance for an Autonomous Vehicle

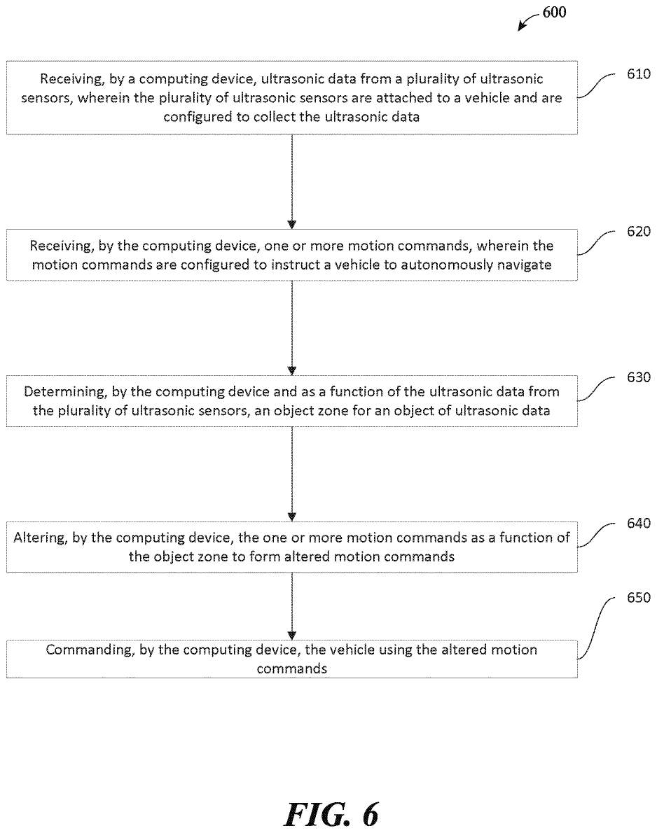

Referring now to FIG. 6, a method 600 for emergency collision avoidance for an autonomous vehicle is shown. The method 600 includes a step 610 of receiving, by a computing device, ultrasonic data from a plurality of ultrasonic sensors, wherein the plurality of ultrasonic sensors are attached to a vehicle and are configured to collect the ultrasonic data. This may be implemented, without limitation, as described with reference to FIGS. 1-5B above.

With continued reference to FIG. 6, method 600 includes a step 620 of receiving, by the computing device, one or more motion commands, wherein the motion commands are configured to instruct a vehicle to autonomously navigate. This may be implemented, without limitation, as described with reference to FIGS. 1-5B above.

With continued reference to FIG. 6, method 600 includes a step 630 of determining, by the computing device and as a function of the ultrasonic data from the plurality of ultrasonic sensors, an object zone for an object of ultrasonic data. This may be implemented, without limitation, as described with reference to FIGS. 1-5B above.

With continued reference to FIG. 6, method 600 includes a step 640 of altering, by the computing device, the one or more motion commands as a function of the object zone to form altered motion commands. This may be implemented, without limitation, as described with reference to FIGS. 1-5B above.

With continued reference to FIG. 6, method 600 includes a step 650 of commanding, by the computing device, the vehicle using the altered motion commands.

With continued reference to FIG. 6, the computing device referenced with respect to FIG. 6 may include, e.g., main compute unit 404 and chassis compute unit 408 in a distributed architecture, with each of main compute unit 404 and chassis compute unit 408 performing actions as described further with reference to FIG. 4.

In some aspects, the techniques described herein relate to a method, wherein determining the object zone for the object of the ultrasonic data includes: determining an object zone to be a single sensor zone if the object is only detected in the ultrasonic data from one ultrasonic sensor of the plurality of ultrasonic sensors; and determining the object zone to be in a triangulation zone if the object is detected in the ultrasonic data from each of the plurality of ultrasonic sensors.

In some aspects, the techniques described herein relate to a method, wherein altering the one or more motion commands as a function of the object zone to form altered motion commands includes: if the object zone is the triangulation zone: determining an object collision risk as a function of the ultrasonic data; allowing the motion commands if the object collision risk is negative; and overriding the motion commands to institute a safety protocol if the object collision risk is positive; and if the object zone is in the single sensor zone, overriding the motion commands to institute the safety protocol if the object zone is the single sensor zone.

In some aspects, the techniques described herein relate to a method, wherein: the plurality of ultrasonic sensors includes a first ultrasonic sensor and a second ultrasonic sensor; the first ultrasonic sensor is located: on a front side of the vehicle; and to a left of a longitudinal axis of the vehicle; and the second ultrasonic sensor is located: on the front side of the vehicle; and to a right of the longitudinal axis of the vehicle.

In some aspects, the techniques described herein relate to a method, wherein determining the object zone for the object of the ultrasonic data includes: determining an object zone to be a near single sensor zone if an object is detected by only one ultrasonic sensor within a path of the vehicle; determining the object zone to be a far single sensor zone if an object is detected by only one ultrasonic sensor outside of the path of the vehicle; and determining the object zone to be in a triangulation zone if the object is detected in the ultrasonic data from each of the plurality of ultrasonic sensors.

In some aspects, the techniques described herein relate to a method, wherein altering the one or more motion commands as a function of the object zone to form altered motion commands includes: if the object zone is the triangulation zone: determining an object collision risk as a function of the ultrasonic data; allowing the motion commands if the object collision risk is negative; and overriding the motion commands to institute a safety protocol if the object collision risk is positive; and if the object zone is determined to be the far single sensor zone: allowing the motion commands if the object zone is determined to be the near single sensor zone: overriding the motion commands to institute the safety protocol.

In some aspects, the techniques described herein relate to a method, wherein instituting the safety protocol includes applying brakes.

In some aspects, the techniques described herein relate to a method for emergency collision avoidance for an autonomous vehicle, the method including: generating, using a main compute unit, one or more motion commands as a function of sensor suite data; receiving, by a chassis compute unit, ultrasonic data from a plurality of ultrasonic sensors, wherein the plurality of ultrasonic sensors are attached to a vehicle and are configured to collect the ultrasonic data; receiving, by the chassis compute unit, one or more motion commands from the main compute unit, wherein the motion commands are configured to instruct a vehicle to autonomously navigate; determining, by the chassis compute unit and as a function of the ultrasonic data from the plurality of ultrasonic sensors, an object zone for an object of ultrasonic data; altering, by the chassis compute unit, the one or more motion commands as a function of the object zone to form altered motion commands; and commanding, by the chassis compute unit, the vehicle using the altered motion commands.

### Exemplary Computing Device in the Exemplary Form of a Computer System

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 7 shows a diagrammatic representation of one embodiment of a computing device in the exemplary form of a computer system 700 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 700 includes a processor 705 and a memory 710 that communicate with each other, and with other components, via a bus 715. Bus 715 may include any of several types of bus structures including, but not limited to, a memory bus, a memory controller, a peripheral bus, a local bus, and any combinations thereof, using any of a variety of bus architectures.

Processor 705 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 705 may be organized according to Von Neumann and/or Harvard architecture as a non-limiting example. Processor 705 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a control circuit or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulo's algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 710 may include various components (e.g., machine-readable media) including, but not limited to, a random-access memory component, a read only component, and any combinations thereof. In one example, a basic input/output system 720 (BIOS), including basic routines that help to transfer information between elements within computer system 700, such as during start-up, may be stored in memory 710. Memory 710 may also include (e.g., stored on one or more machine-readable media) instructions (e.g., software) 725 embodying any one or more of the aspects and/or methodologies of the present disclosure. In another example, memory 710 may further include any number of program modules including, but not limited to, an operating system, one or more application programs, other program modules, program data, and any combinations thereof. Memory 710 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power.

Computer system 700 may also include a storage device 730. Examples of a storage device (e.g., storage device 730) include, but are not limited to, a hard disk drive, a magnetic disk drive, an optical disc drive in combination with an optical medium, a solid-state memory device, and any combinations thereof. Storage device 730 may be connected to bus 715 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 730 (or one or more components thereof) may be removably interfaced with computer system 700 (e.g., via an external port connector (not shown)). Particularly, storage device 730 and an associated machine-readable medium may provide nonvolatile and/or volatile storage of machine-readable instructions, data structures, program modules, and/or other data for computer system 700. In some embodiments, storage device 730 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry may access the information from primary memory. In one example, software (e.g., instructions 725) may reside, completely or partially, within machine-readable medium. In another example, software may reside, completely or partially, within processor 705.

Computer system 700 may also include an input device 740. In one example, a user of computer system 700 may enter commands and/or other information into computer system 700 via input device 740. Examples of an input device 740 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 740 may be interfaced to bus 715 via any of a variety of interfaces (not shown) including, but not limited to, a serial interface, a parallel interface, a game port, a USB interface, a FIREWIRE interface, a direct interface to bus 715, and any combinations thereof. Input device 740 may include a touch screen interface that may be a part of or separate from display 745, discussed further below. Input device 740 may be utilized as a user selection device for selecting one or more graphical representations in a graphical interface as described above.

A user may also input commands and/or other information to computer system 700 via storage device 730 (e.g., a removable disk drive, a flash drive, etc.) and/or network interface device 750. A network interface device, such as network interface device 750, may be utilized for connecting computer system 700 to one or more of a variety of networks, such as network 755, and one or more remote devices 760 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 755, may employ a wired and/or a wireless mode of communication. In general, any network topology may be used. Information (e.g., data, software, etc.) may be communicated to and/or from computer system 700 via network interface device 750.

Computer system 700 may further include a video display adapter 765 for communicating a displayable image to a display device, such as display 745. Examples of a display device include, but are not limited to, a liquid crystal display (LCD), a cathode ray tube (CRT), a plasma display, a light emitting diode (LED) display, and any combinations thereof. Display adapter 765 and display 745 may be utilized in combination with processor 705 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 715 via a peripheral interface 770. Examples of a peripheral interface include, but are not limited to, a serial port, a USB connection, a FIREWIRE connection, a parallel connection, and any combinations thereof.

Further referring to FIG. 7, a computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single device having components as described above operating independently, or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 7, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 7, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware and/or memory. Examples of operating systems include without limitation Unix, Linux, Microsoft Windows, Android, Disc Operating System (DOS) and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 700, processor 705, and memory 710 may be virtualized; that is, a virtual machine and/or container may interact directly with such computing system 700, processor 705, and/or memory 710, while managing communications therefrom and thereto via a virtual interface with programs. Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 705 comprises a plurality of processors and/or processor cores, virtualization may, in some cases, simulate or emulate a single (virtual) processor whose functions are allocated to one or more of the plurality of processors and/or processor cores. In this case, while processor 705 may be said to be virtualized, the processor 705, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU, www.qemu.org; (2) VMware by Broadcom Inc of Palo Alto, California; (3) VirtualBox by Oracle Corporation headquartered in Austin, Texas; and (4) kernel-based virtual machine (KVM) www.linux-kvm.org.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, as discussed above, it should be understood that the particular system and method used to implement the instant disclosure may be modified without changing the spirit of the disclosure and as such the various art-recognized alternatives are within the scope of the present application.

It is to be understood that wherever values and ranges are provided herein, all values and ranges encompassed by these values and ranges, are meant to be encompassed within the scope of the present invention. Moreover, all values that fall within these ranges, as well as the upper or lower limits of a range of values, are also contemplated by the present application.

The following examples further illustrate aspects of the present invention. However, they are in no way a limitation of the teachings or disclosure of the present invention as set forth herein.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

What is claimed is:

1. A system for emergency collision avoidance for an autonomous vehicle, the system comprising:
a vehicle;
a plurality of ultrasonic sensors attached to the vehicle and configured to collect ultrasonic data; and
a computing device, wherein the computing device is configured to:
receive the ultrasonic data from the plurality of ultrasonic sensors;
receive one or more motion commands, wherein the motion commands are configured to instruct a vehicle to autonomously navigate;
determine, as a function of the ultrasonic data from the plurality of ultrasonic sensors, an object zone for an object of ultrasonic data;
alter the one or more motion commands as a function of the object zone to form altered motion commands; and
command the vehicle using the altered motion commands.

2. The system of claim 1, wherein determining the object zone for the object of the ultrasonic data comprises:
determining an object zone to be a single sensor zone if the object is only detected in the ultrasonic data from one ultrasonic sensor of the plurality of ultrasonic sensors; and
determining the object zone to be in a triangulation zone if the object is detected in the ultrasonic data from each of the plurality of ultrasonic sensors.

3. The system of claim 2, wherein altering the one or more motion commands as a function of the object zone to form altered motion commands comprises:
if the object zone is the triangulation zone:
determining an object collision risk as a function of the ultrasonic data;
allowing the motion commands if the object collision risk is negative; and
overriding the motion commands to institute a safety protocol if the object collision risk is positive; and
if the object zone is in the single sensor zone, overriding the motion commands to institute the safety protocol if the object zone is the single sensor zone.

4. The system of claim 1, wherein the plurality of ultrasonic sensors comprises a first ultrasonic sensor and a second ultrasonic sensor.

5. The system of claim 4, wherein:
the first ultrasonic sensor is located:
on a front side of the vehicle; and
to a left of a longitudinal axis of the vehicle; and
the second ultrasonic sensor is located:
on the front side of the vehicle; and
to a right of the longitudinal axis of the vehicle.

6. The system of claim 4, wherein determining the object zone for the object of the ultrasonic data comprises:
determining an object zone to be a near single sensor zone if an object is detected by only one ultrasonic sensor within a path of the vehicle;
determining the object zone to be a far single sensor zone if an object is detected by only one ultrasonic sensor outside of the path of the vehicle; and
determining the object zone to be in a triangulation zone if the object is detected in the ultrasonic data from each of the plurality of ultrasonic sensors.

7. The system of claim 6, wherein altering the one or more motion commands as a function of the object zone to form altered motion commands comprises:
if the object zone is the triangulation zone:
determining an object collision risk as a function of the ultrasonic data;
allowing the motion commands if the object collision risk is negative; and
overriding the motion commands to institute a safety protocol if the object collision risk is positive; and
if the object zone is determined to be the far single sensor zone:
allowing the motion commands
if the object zone is determined to be the near single sensor zone:
overriding the motion commands to institute the safety protocol.

8. The system of claim 7, wherein the safety protocol comprises applying brakes.

9. The system of claim 1, wherein receiving the ultrasonic data from the plurality of ultrasonic sensors comprises:
first emitting a first ultrasonic pulse with a first ultrasonic sensor while detecting ultrasonic data with a second ultrasonic sensor; and
second emitting a second ultrasonic pulse with the second ultrasonic sensor while detecting the ultrasonic data with the first ultrasonic sensor.

10. The system of claim 1, wherein the computing device comprises:
a main compute unit; and
a chassis control unit.

11. The system of claim 10, wherein:
the main compute unit is configured to:
generate the one or more motion commands as a function of sensor suite data; and
the chassis compute unit is configured to:
receive the one or more motion commands from the main compute unit;
receive the ultrasonic data from the plurality of ultrasonic sensors;
determine, as a function of the ultrasonic data from the plurality of ultrasonic sensors, the object zone for the object of ultrasonic data;
altering the one or more motion commands as a function of the object zone to form altered motion commands; and
commanding the vehicle using the altered motion commands.

12. The system of claim 1, wherein the vehicle comprises a car.

13. A method for emergency collision avoidance for an autonomous vehicle, the method comprising:
receiving, by a computing device, ultrasonic data from a plurality of ultrasonic sensors, wherein the plurality of ultrasonic sensors are attached to a vehicle and are configured to collect the ultrasonic data;
receiving, by the computing device, one or more motion commands, wherein the motion commands are configured to instruct a vehicle to autonomously navigate;
determining, by the computing device and as a function of the ultrasonic data from the plurality of ultrasonic sensors, an object zone for an object of ultrasonic data;
altering, by the computing device, the one or more motion commands as a function of the object zone to form altered motion commands; and
commanding, by the computing device, the vehicle using the altered motion commands.

14. The method of claim 13, wherein determining the object zone for the object of the ultrasonic data comprises:
determining an object zone to be a single sensor zone if the object is only detected in the ultrasonic data from one ultrasonic sensor of the plurality of ultrasonic sensors; and
determining the object zone to be in a triangulation zone if the object is detected in the ultrasonic data from each of the plurality of ultrasonic sensors.

15. The method of claim 14, wherein altering the one or more motion commands as a function of the object zone to form altered motion commands comprises:
if the object zone is the triangulation zone:
determining an object collision risk as a function of the ultrasonic data;
allowing the motion commands if the object collision risk is negative; and
overriding the motion commands to institute a safety protocol if the object collision risk is positive; and
if the object zone is in the single sensor zone, overriding the motion commands to institute the safety protocol if the object zone is the single sensor zone.

16. The method of claim 13, wherein:
the plurality of ultrasonic sensors comprises a first ultrasonic sensor and a second ultrasonic sensor;
the first ultrasonic sensor is located:
on a front side of the vehicle; and
to a left of a longitudinal axis of the vehicle; and
the second ultrasonic sensor is located:
on the front side of the vehicle; and
to a right of the longitudinal axis of the vehicle.

17. The method of claim 16, wherein determining the object zone for the object of the ultrasonic data comprises:
determining an object zone to be a near single sensor zone if an object is detected by only one ultrasonic sensor within a path of the vehicle;
determining the object zone to be a far single sensor zone if an object is detected by only one ultrasonic sensor outside of the path of the vehicle; and
determining the object zone to be in a triangulation zone if the object is detected in the ultrasonic data from each of the plurality of ultrasonic sensors.

18. The method of claim 17, wherein altering the one or more motion commands as a function of the object zone to form altered motion commands comprises:
if the object zone is the triangulation zone:
determining an object collision risk as a function of the ultrasonic data;
allowing the motion commands if the object collision risk is negative; and
overriding the motion commands to institute a safety protocol if the object collision risk is positive; and
if the object zone is determined to be the far single sensor zone:
allowing the motion commands
if the object zone is determined to be the near single sensor zone:
overriding the motion commands to institute the safety protocol.

19. The method of claim 18, wherein instituting the safety protocol comprises applying brakes.

20. A method for emergency collision avoidance for an autonomous vehicle, the method comprising:
generating, using a main compute unit, one or more motion commands as a function of sensor suite data;
receiving, by a chassis compute unit, ultrasonic data from a plurality of ultrasonic sensors, wherein the plurality of ultrasonic sensors are attached to a vehicle and are configured to collect the ultrasonic data;
receiving, by the chassis compute unit, one or more motion commands from the main compute unit, wherein the motion commands are configured to instruct a vehicle to autonomously navigate;
determining, by the chassis compute unit and as a function of the ultrasonic data from the plurality of ultrasonic sensors, an object zone for an object of ultrasonic data;
altering, by the chassis compute unit, the one or more motion commands as a function of the object zone to form altered motion commands; and
commanding, by the chassis compute unit, the vehicle using the altered motion commands.
